(19) United States
(12) Patent Application Publication
(10) Pub. No.: US 2026/0360968 A1
(43) Pub. Date: Nov. 12, 2026

(54) SHARED-APERTURE ANTENNA AND METHOD OF MANUFACTURING THE SAME

(71) Applicant: ELECTRONICS AND TELECOMMUNICATIONS RESEARCH INSTITUTE, Daejeon (KR)

(72) Inventors: Seong Mo MOON, Daejeon (KR); Hakmin LEE, Daejeon (KR); Dong Pil CHANG, Daejeon (KR); Han Lim LEE, Seoul (KR); Seung-Soo HAN, Seoul (KR)

(73) Assignee: ELECTRONICS AND TELECOMMUNICATIONS RESEARCH INSTITUTE, Daejeon (KR)

(21) Appl. No.: 19/293,479

(22) Filed: Aug. 7, 2025

(30) Foreign Application Priority Data
May 8, 2025 (KR) 10-2025-0060004

(51) Int. Cl. H01Q 1/28; H01Q 9/04; H01Q 21/06

(52) U.S. Cl. CPC H01Q 1/288; H01Q 9/0442; H01Q 21/065

(57) ABSTRACT

An antenna for inter-satellite communications is provided. The antenna includes a substrate having a planar structure and including a dielectric, a first radio-frequency integrated circuit (RFIC) disposed on the substrate, and a plurality of second RFICs disposed on the substrate and spaced apart from the first RFIC, in which the first RFIC shares the antenna with each of the plurality of second RFICs.

### CROSS-REFERENCE TO RELATED APPLICATION

This application claims the benefit of Korean Patent Application No. 10-2025-0060004, filed on May 8, 2025, in the Korean Intellectual Property Office, the entire disclosure of which is incorporated herein by reference for all purposes.

### BACKGROUND

### 1. Field of the Invention

One or more embodiments relate to a shared-aperture antenna and a method of manufacturing the same.

### 2. Description of the Related Art

Recently, low Earth orbit (LEO) satellite communication systems have gained global attention for their potential to expand various services. In LEO environments, K/Ka-band frequencies may be used as primary communication frequencies to provide high data transmission rates and global coverage. In LEO satellite systems, it may be essential to integrate a transmission module and a reception module within a limited payload space to configure an efficient communication system. However, conventional transceiver systems may exacerbate space constraints of satellite payloads by performing transmission and reception functions through separate antennas. Such a configuration may increase the weight and volume of a satellite, thereby raising the cost of manufacturing and operating the satellite.

Conventional separated transceiver array structures or reflect array structures may have relatively large sizes, making them difficult to apply to small satellite payloads. In addition, stacked array structures may be unsuitable for satellite communication systems due to a large frequency gap between a transmission band and a reception band. In satellite payload environments with space limitations, a planar embedding structure that provides a lower thickness may be more suitable than a three-dimensional embedding structure. However, in existing planar embedding structures, integration of transmission and reception chips has not been considered, which may result in a complicated feeding network and thus limit practical application.

The above description includes information the inventor(s) acquired during the course of conceiving the present disclosure, or already possessed at the time, and is not necessarily art publicly known before the present application was filed.

### SUMMARY

According to an aspect, an antenna includes a single antenna array configured to perform both transmission and reception functions.

According to an aspect, an antenna includes a single antenna array including both a receiver radio-frequency integrated circuit (RFIC) and a transmitter RFIC.

According to an aspect, an antenna includes a receiver RFIC and a transmitter RFIC spaced apart from each other in a single antenna array.

However, technical aspects are not limited to the foregoing aspects, and there may be other technical aspects.

According to an aspect, there is provided an antenna including a substrate having a planar structure and including a dielectric, a first RFIC disposed on the substrate, and a second RFIC disposed on the substrate and spaced apart from the first RFIC, in which the first RFIC shares the antenna with the second RFIC.

The first RFIC may be a receiver RFIC, and the second RFIC may be a transmitter RFIC.

The antenna may include a feeding patch, a capacitor connected in series to a feeding portion of the feeding patch, a dummy conductor disposed around a perimeter of the feeding patch, and a shorting via disposed in the dummy conductor.

The feeding patch of the antenna may have a cross shape with each corner of the feeding patch chamfered.

Each of the first RFIC and the second RFIC may use two feeding portions of the feeding patch of the antenna.

According to an aspect, there is provided a method of manufacturing an antenna including disposing a first RFIC on a substrate having a planar structure and including a dielectric, and disposing a second RFIC on the substrate spaced apart from the first RFIC, in which the first RFIC shares the antenna with the second RFIC.

The first RFIC may be a receiver RFIC, and the second RFIC may be a transmitter RFIC.

The antenna may include a feeding patch, a capacitor connected in series to a feeding portion of the feeding patch, a dummy conductor disposed around a perimeter of the feeding patch, and a shorting via disposed in the dummy conductor.

The feeding patch of the antenna may have a cross shape with each corner of the feeding patch chamfered.

Each of the first RFIC and the second RFIC may use two feeding portions of the feeding patch of the antenna.

According to an aspect, there is provided an electronic device for inter-satellite communications including an antenna, a processor, and memory, in which the antenna includes a substrate having a planar structure and including a dielectric, a first RFIC disposed on the substrate, and a second RFIC disposed on the substrate and spaced apart from the first RFIC, in which the first RFIC shares the antenna with the second RFIC.

The first RFIC may be a receiver RFIC, and the second RFIC may be a transmitter RFIC.

The antenna may include a feeding patch, a capacitor connected in series to a feeding portion of the feeding patch, a dummy conductor disposed around a perimeter of the feeding patch, and a shorting via disposed in the dummy conductor.

The feeding patch of the antenna may have a cross shape with each corner of the feeding patch chamfered.

Each of the first RFIC and the second RFIC may use two feeding portions of the feeding patch of the antenna.

According to an aspect, there is provided an antenna including a substrate having a planar structure and including a dielectric, a first RFIC disposed on the substrate, and a plurality of second RFICs disposed on the substrate and spaced apart from the first RFIC, in which the first RFIC shares the antenna with each of the plurality of second RFICs.

The first RFIC may be a receiver RFIC, and the plurality of second RFICs may be transmitter RFICs.

The antenna may include a feeding patch, a capacitor connected in series to a feeding portion of the feeding patch, a dummy conductor disposed around a perimeter of the feeding patch, and a shorting via disposed in the dummy conductor.

The feeding patch of the antenna may have a cross shape with each corner of the feeding patch chamfered.

Each of the first RFIC and each of the plurality of second RFICs may use two feeding portions of the feeding patch of the antenna.

According to an aspect, there is provided a method of manufacturing an antenna including disposing a first RFIC on a substrate having a planar structure and including a dielectric, and disposing a plurality of second RFICs on the substrate spaced apart from the first RFIC, in which the first RFIC shares the antenna with each of the plurality of second RFICs.

The first RFIC may be a receiver RFIC, and each of the plurality of second RFICs may be a transmitter RFIC.

The antenna may include a feeding patch, a capacitor connected in series to a feeding portion of the feeding patch, a dummy conductor disposed around a perimeter of the feeding patch, and a shorting via disposed in the dummy conductor.

The feeding patch of the antenna may have a cross shape with each corner of the feeding patch chamfered.

Each of the first RFIC and each of the plurality of second RFICs may use two feeding portions of the feeding patch of the antenna.

According to an aspect, there is provided an electronic device for inter-satellite communications including an antenna, a processor, and memory, in which the antenna includes a substrate having a planar structure and including a dielectric, a first RFIC disposed on the substrate, and a plurality of second RFICs disposed on the substrate and spaced apart from the first RFIC, in which the first RFIC shares the antenna with each of the plurality of second RFICs.

The first RFIC may be a receiver RFIC, and the plurality of second RFICs may be transmitter RFICs.

The antenna may include a feeding patch, a capacitor connected in series to a feeding portion of the feeding patch, a dummy conductor disposed around a perimeter of the feeding patch, and a shorting via disposed in the dummy conductor.

The feeding patch of the antenna may have a cross shape with each corner of the feeding patch chamfered.

Each of the first RFIC and each of the plurality of second RFICs may use two feeding portions of the feeding patch of the antenna.

### BRIEF DESCRIPTION OF THE DRAWINGS

FIG. 1 illustrates an antenna array according to an embodiment.

FIG. 2 illustrates a transmitter array and a receiver array.

FIG. 3 illustrates an antenna according to an embodiment.

FIG. 4 illustrates an antenna design method according to an embodiment.

FIG. 5 illustrates Smith charts and reflection coefficient graphs corresponding to each step of an antenna design method according to an embodiment.

FIG. 6 illustrates an equivalent circuit modeling process of a feeding patch of an antenna according to an embodiment.

FIG. 7 illustrates the structure of an antenna array according to an embodiment.

FIG. 8 illustrates a beamformer chip and beamforming network according to an embodiment.

FIG. 9 illustrates reflection coefficients of an antenna according to an embodiment.

FIG. 10 illustrates a radiation pattern of an antenna according to an embodiment.

FIG. 11 illustrates a graph of an axial ratio of an antenna according to an embodiment.

FIG. 12 illustrates an antenna manufacturing method according to an embodiment.

FIG. 13 illustrates a schematic block diagram of an electronic device according to an embodiment.

### DETAILED DESCRIPTION

The following detailed structural or functional description is provided as an example only and various alterations and modifications may be made to the examples. Accordingly, the embodiments are not to be construed as limited to the disclosure and should be understood to include all changes, equivalents, or replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is "connected", "coupled", or "joined" to another component, a third component may be "connected", "coupled", and "joined" between the first and second components, although the first component may be directly connected, coupled, or joined to the second component.

The singular forms "a", "an", and "the" include the plural forms as well, unless the context clearly indicates otherwise. As used herein, "A or B", "at least one of A and B", "at least one of A or B", "A, B or C", "at least one of A, B and C", and "at least one of A, B, or C," each of which may include any one of the items listed together in the corresponding one of the phrases, or all possible combinations thereof. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. Terms, such as those defined in commonly used dictionaries, are to be interpreted as having a meaning that is consistent with their meaning in the context of the relevant art and are not to be interpreted in an idealized or overly formal sense unless expressly so defined herein.

The term "unit" or the like used herein may refer to a software or hardware component, such as a field-programmable gate array (FPGA) or an application-specific integrated circuit (ASIC), and the "unit" performs predefined functions. However, the term "unit" is not limited to software or hardware. A "unit" may be configured to be in an addressable storage medium or configured to operate one or more processors. Accordingly, the "unit" may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and "units" may be combined into fewer components and "units" or may be further separated into additional components and "units." Furthermore, the components and "units" may be implemented to operate on one or more central processing units (CPUs) within a device or a security multimedia card. In addition, "unit" may include one or more processors.

Hereinafter, embodiments will be described in detail with reference to the accompanying drawings. When describing the embodiments with reference to the accompanying drawings, like reference numerals refer to like elements and a repeated description related thereto will be omitted.

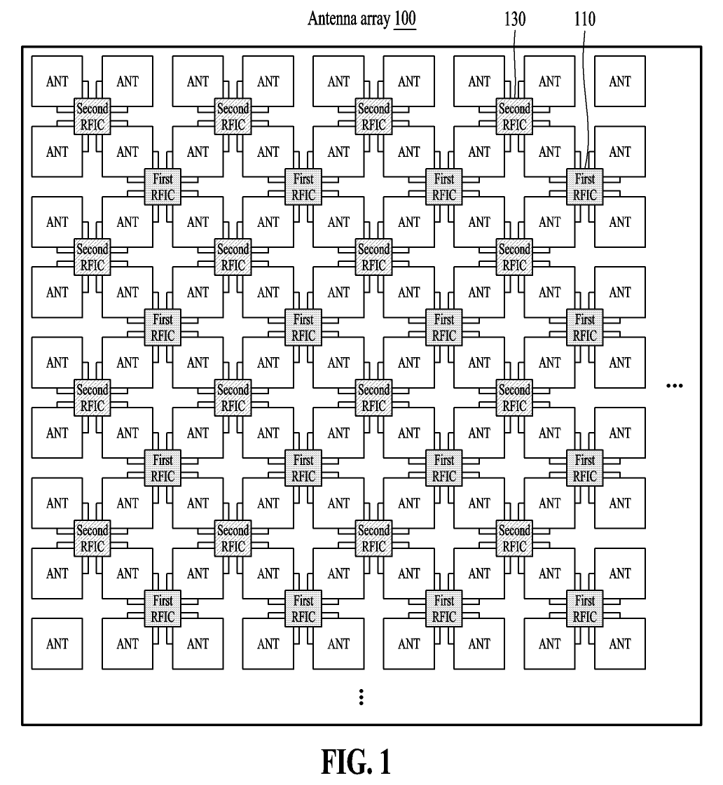

FIG. 1 illustrates an antenna array according to an embodiment.

Referring to FIG. 1, according to an embodiment, an antenna array 100 may include a first radio-frequency integrated circuit (RFIC) 110 and a second RFIC 130.

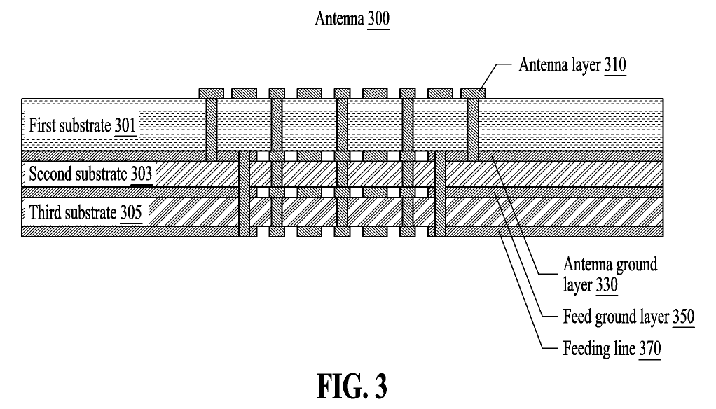

The antenna array 100 may be used for communication. For example, the antenna array 100 may be used for inter-satellite communications. The satellites may be low Earth orbit (LEO) satellites. The antenna array 100 may be configured to perform both transmission and reception functions through the same aperture. Accordingly, an antenna (e.g., antenna 300 of FIG. 3) may simultaneously perform transmission and reception functions. As the transmission and reception functions of the antenna 300 are integrated, the integration level of the transmission and reception functions of the antenna 300 may be increased. As a result, the system stability of the antenna 300 may also be improved. The transmission and reception of the antenna 300 may use different frequency bands.

The first RFIC 110 may perform a transmission and/or reception function. The first RFIC 110 may perform the transmission and/or reception function in a specific frequency band. For example, the transmission and/or reception function may be performed in a first frequency band. The first RFIC 110 may be electrically connected to an antenna element. The first RFIC 110 may perform feeding control and signal processing on the antenna element.

The second RFIC 130 may perform a transmission and/or reception function. The second RFIC 130 may perform the transmission and/or reception function in a specific frequency band. For example, the second RFIC 130 may perform the transmission and/or reception function in a second frequency band. The second RFIC 130 may be electrically connected to an antenna element. The second RFIC 130 may perform feeding control and signal processing on the antenna element.

The first RFIC 110 and the second RFIC 130 may be disposed on the same substrate. The first RFIC 110 and the second RFIC 130 may operate independently. The first RFIC 110 and the second RFIC 130 may be designed to operate without interfering with each other.

The antenna array 100 may perform transmission and reception functions in different frequency bands. The antenna 300 may be miniaturized through a structure of the antenna array 100 that shares the same aperture for both transmission and reception functions. Accordingly, the antenna array 100 may exhibit high space efficiency and may be particularly useful in space-constrained environments. For example, the antenna array 100 may be used in an antenna mounted on a LEO satellite payload with severe space limitations. In addition, the antenna array 100 may be applicable in various wireless communication fields such as Earth observation, remote sensing, and multi-function radar. The antenna array 100 may reduce the complexity of the system, layout, and feeding network of the antenna 300. The antenna array 100 may also reduce the size, weight, and volume of the antenna 300.

The antenna array 100 may improve the efficiency of inter-satellite communications. The antenna array 100 may improve the space efficiency of satellites. The antenna array 100 may improve the cost-effectiveness and performance of LEO satellite communication systems.

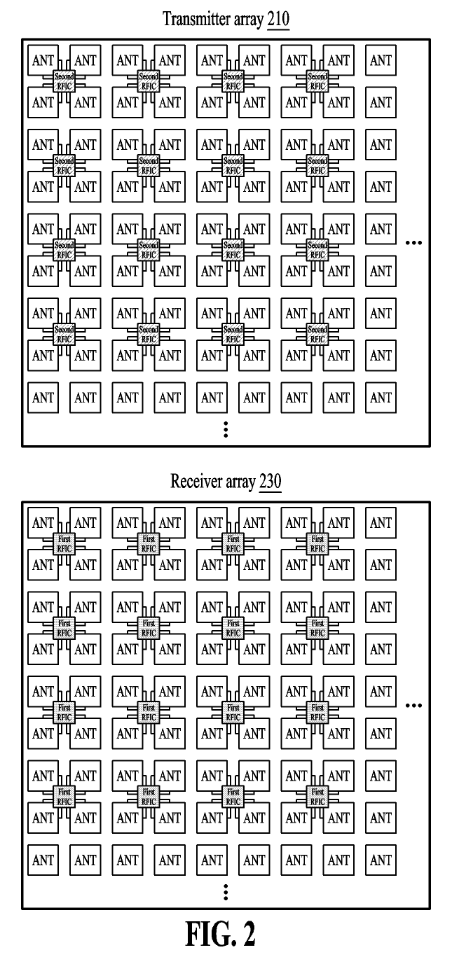

FIG. 2 illustrates a transmitter array and a receiver array.

Referring to FIG. 2, according to an embodiment, a conventional antenna may include a transmission array 210 and a reception array 230 that are separated from each other.

The transmission array 210 and the reception array 230 may respectively perform transmission and reception functions. The transmission array 210 and the reception array 230 may perform the transmission and reception functions in different frequency bands.

The transmission array 210 may include only transmission RFICs. Only transmission RFICs may be disposed in the transmission array 210.

The reception array 230 may include only reception RFICs. Only reception RFICs may be disposed in the reception array 230.

When the transmission array 210 and the reception array 230 are separated, a conventional antenna may require two boards to perform transmission and reception functions. To improve the space efficiency of the antenna, an antenna array capable of performing transmission and reception simultaneously may be required.

FIG. 3 illustrates an antenna according to an embodiment.

Referring to FIG. 3, according to an embodiment, the antenna 300 may have a multilayer structure. For example, the antenna 300 may include four layers. The four layers may include an antenna layer 310, an antenna ground layer 330, a feed ground layer 350, and a feeding line 370.

The antenna layer 310 may be the top layer of the antenna 300. The antenna layer 310 may radiate electromagnetic waves. The antenna layer 310 may be disposed on a first substrate 301. The first substrate 301 may be a TLX-9 substrate. The first substrate 301 may have a predetermined thickness; for example, the first substrate 301 may have a thickness of 1.14 mm. The first substrate 301 may have a dielectric constant of 2.5 and a loss tangent of 0.0015.

The antenna ground layer 330 may provide a reference potential. The antenna ground layer 330 may provide the reference potential to allow the antenna 300 to stably radiate or receive electromagnetic waves. The antenna ground layer 330 may be disposed on a second substrate 303. The second substrate 303 may be an RO4450B substrate. The second substrate 303 may have a thickness of 1.14 mm. The second substrate 303 may have a dielectric constant of 3.7 and a loss tangent of 0.0025.

The feed ground layer 350 may serve as a ground plane of the feeding line 370. The feed ground layer 350 may be electromagnetically coupled to the feeding line 370. The feed ground layer 350 may be disposed on a third substrate 305. The third substrate 305 may be an RF-35 substrate. The third substrate 305 may have a thickness of 0.254 mm. The third substrate 305 may have a dielectric constant of 3.5 and a loss tangent of 0.0025.

The feeding line 370 may be the bottom layer of the antenna 300. The feeding line 370 may transmit radio-frequency (RF) signals. The feeding line 370 may supply RF signals to the antenna layer 310.

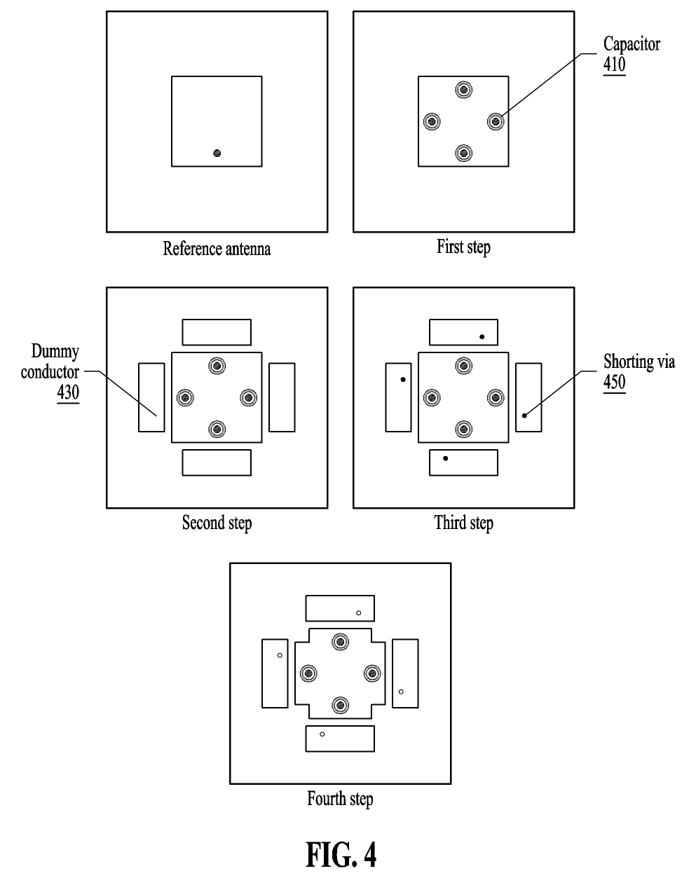

FIG. 4 illustrates an antenna design method according to an embodiment.

Referring to FIG. 4, according to an embodiment, the antenna 300 may have multiple ports. The antenna 300 may be used for satellite communication. For example, the antenna 300 may be used for satellite communications in the Ka-band. The antenna 300 may support downlink and uplink communications in specific frequency bands. For example, the antenna 300 may support downlink communication at 17.721 GHz and uplink communication at 27.731 GHz.

The antenna 300 may be designed based on a reference antenna. The antenna 300 may be designed through four steps starting from the reference antenna.

The first step may be coupling a capacitor 410 to feeding portions of the reference antenna. For example, the first step may include coupling the capacitor 410 to four feeding portions of the reference antenna. When the capacitor 410 is coupled to the feeding portions of the reference antenna, the quality factor of the antenna 300 may decrease. Accordingly, the bandwidth of the antenna 300 may increase. The smaller the gap size of the capacitor 410, the greater the increase in the bandwidth of the antenna 300 may be. The gap size of the capacitor 410 may be determined considering manufacturing process limitations.

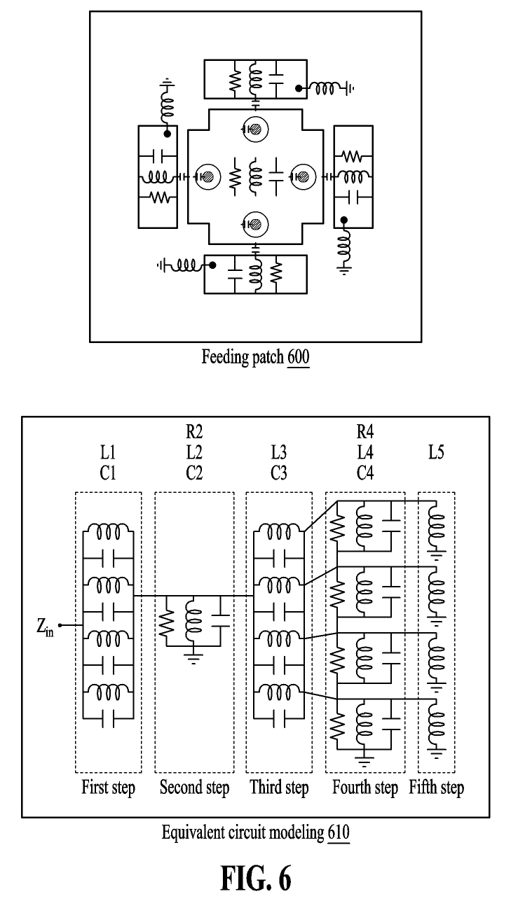

The second step may be disposing a dummy conductor 430 around a feeding patch (e.g., a feeding patch 600 of FIG. 6) of the antenna. The disposition of the dummy conductor 430 may include adding a series capacitor component to the antenna 300. When the dummy conductor 430 is disposed in the antenna 300, a gain difference between a high frequency band and a low frequency band may be reduced.

The third step may be disposing a shorting via 450 in the dummy conductor 430. The disposition of the shorting via 450 may include adding a parallel inductance component to the antenna 300. When the shorting via 450 is disposed in the dummy conductor 430, impedance matching may be achieved in the downlink and uplink frequency bands of the antenna 300. In addition, disposing the shorting via 450 in the dummy conductor 430 may reduce a gain difference between a high frequency band and a low frequency band of the antenna 300.

The fourth step may be chamfering corners of the feeding patch 600. For example, the feeding patch 600 may have a cross shape with each corner chamfered. Chamfering the corners of the feeding patch 600 may adjust a reactance component in a low frequency band of the antenna 300.

The antenna 300 may be designed step by step from the reference antenna. The antenna 300 may be designed by coupling the capacitor 410 to the reference antenna, adding the dummy conductor 430, and disposing the shorting via 450. The antenna 300 may include the feeding patch 600, the capacitor 410 connected in series to feeding portions of the feeding patch, the dummy conductor 430 disposed around the perimeter of the feeding patch, and the shorting via 450 disposed in the dummy conductor 430.

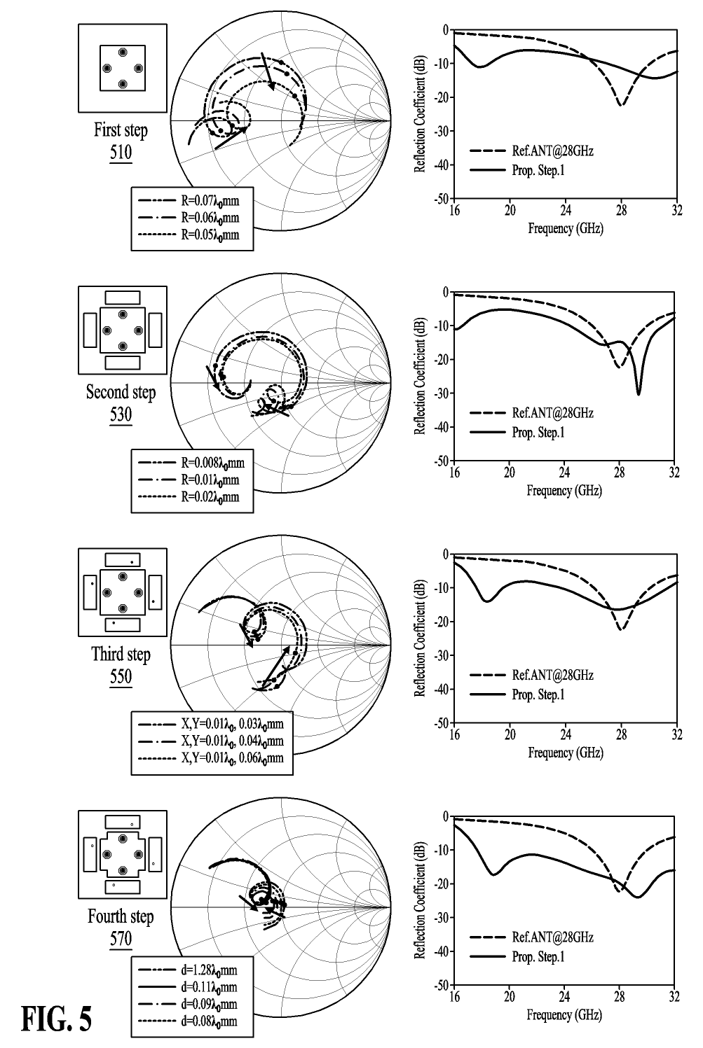

FIG. 5 illustrates Smith charts and reflection coefficient graphs corresponding to each step of an antenna design method according to an embodiment.

The Smith chart and the reflection coefficient graph corresponding to the first step 510 may represent the performance of the antenna 300 in which the capacitor 410 is coupled to the feeding portions of the reference antenna. The Smith chart for the first step 510 shows that a reactance component of the antenna 300 traces a large trajectory. This indicates the effect of adding a series capacitor component to increase the reactance of the antenna 300. The reflection coefficient graph corresponding to the first step 510 shows that the frequency bandwidth over which the reflection coefficient of the antenna 300 is reduced has expanded compared to that of the reference antenna.

The Smith chart and the reflection coefficient graph corresponding to the second step 530 may represent the performance of the antenna 300 in which the dummy conductor 430 is disposed around a feeding patch (e.g., the feeding patch 600 of FIG. 6). The Smith chart for the second step 530 shows that, compared to the first step 510, the impedance trajectory of the antenna 300 shifts toward the center point (or matching point). This indicates the effect of enhancing the series capacitor component by adding the dummy conductor 430 to the antenna 300. It may also be interpreted that the impedance matching characteristics of the antenna 300 have improved compared to the first step 510. The reflection coefficient graph corresponding to the second step 530 shows that the frequency bandwidth over which the reflection coefficient of the antenna 300 satisfies -10 dB or less has further expanded compared to the first step 510.

The Smith chart and the reflection coefficient graph corresponding to the third step 550 may represent the performance of the antenna 300 in which the shorting via 450 is disposed in the dummy conductor 430. The Smith chart for the third step 550 shows that, compared to the second step 530, the impedance trajectory of the antenna 300 converges more closely to the center point. This indicates the effect of adding a parallel inductance component to the antenna 300 by disposing the shorting via 450 in the dummy conductor 430. The reflection coefficient graph corresponding to the third step 550 shows that the reflection coefficient of the antenna 300 is maintained at or below -10 dB.

The Smith chart and the reflection coefficient graph corresponding to the fourth step 570 may represent the performance of the antenna 300 in which corners of the feeding patch 600 are chamfered. The Smith chart for the fourth step 570 shows that the impedance trajectory of the antenna 300 approaches the center point. This indicates the effect of finely adjusting a reactance component in a low frequency band of the antenna 300 by chamfering the corners of the feeding patch 600. The reflection coefficient graph corresponding to the fourth step 570 shows that the reflection coefficient of the antenna 300 is maintained at or below -10 dB.

FIG. 6 illustrates an equivalent circuit modeling process of a feeding patch of an antenna according to an embodiment.

Referring to FIG. 6, according to an embodiment, equivalent circuit modeling 610 may represent a process of modeling the electromagnetic structure of the feeding patch 600 as an equivalent circuit.

Referring to the first step, the feeding path of the feeding patch 600 may be modeled as an LC circuit including a series inductor L1 and a parallel capacitor C1.

Referring to the second step, a resistor-inductor-capacitor (RLC) circuit including a resistor R2, an inductor L2, and a capacitor C2, which are connected in parallel, may be added to the feeding path of the feeding patch 600.

Referring to the third step, an LC resonator including an inductor L3 and a capacitor C3 may be added to the feeding path of the feeding patch 600.

Referring to the fourth step, multiple RLC circuits including a resistor R4, an inductor L4, and a capacitor C4 may be added to the feeding path of the feeding patch 600. The RLC circuits may be circuits connected in parallel.

Referring to the fifth step, a grounded inductor L5 may be connected to the feeding path of the feeding patch 600.

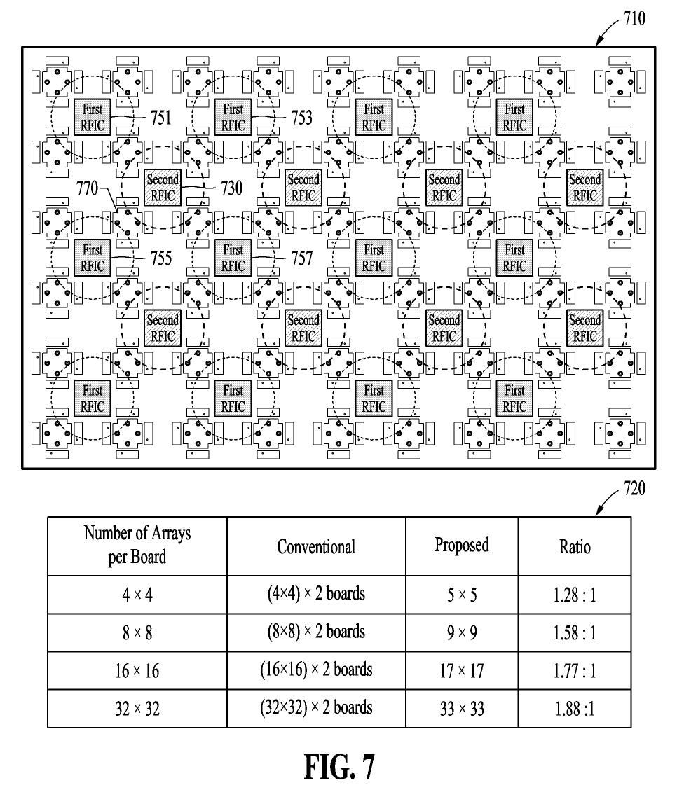

FIG. 7 illustrates the structure of an antenna array according to an embodiment.

Referring to FIG. 7, according to an embodiment, an antenna array 710 may include a plurality of RFICs. The antenna array 710 may include first RFICs (e.g., a first RFIC 751, a first RFIC 753, a first RFIC 755, and a first RFIC 757) and a second RFIC (e.g., a second RFIC 730). The antenna array 710 may have a structure in which multiple different RFICs share a single antenna (e.g., an antenna 770). The antenna array 710 may be the same as the antenna array 100 of FIG. 1.

The antenna array 710 may be disposed on a substrate. The substrate may be a planar structure including a dielectric. The first RFICs (e.g., the first RFIC 751, the first RFIC 753, the first RFIC 755, and the first RFIC 757) may be disposed on the substrate. The second RFIC (e.g., the second RFIC 730) may also be disposed on the substrate. The second RFIC (e.g., the second RFIC 730) may be disposed on the substrate spaced apart from the first RFICs (e.g., the first RFIC 751, the first RFIC 753, the first RFIC 755, and the first RFIC 757). For example, the second RFIC 730 may be disposed at the center of the first RFIC 751, the first RFIC 753, the first RFIC 755, and the first RFIC 757. The first RFICs (e.g., the first RFIC 751, the first RFIC 753, the first RFIC 755, and the first RFIC 757) may share an antenna (e.g., the antenna 770) with the second RFIC (e.g., the second RFIC 730). For example, the second RFIC 730 may share the antenna (e.g., the antenna 770) with each of the first RFICs 751, 753, 755, and 757. The first RFICs (e.g., the first RFIC 751, the first RFIC 753, the first RFIC 755, and the first RFIC 757) and the second RFIC (e.g., the second RFIC 730) may use a specific number of feeding portions of a feeding patch of the antenna (e.g., the antenna 770). For example, the first RFICs (e.g., the first RFIC 751, the first RFIC 753, the first RFIC 755, and the first RFIC 757) and the second RFIC (e.g., the second RFIC 730) may each use two feeding portions of the feeding patch of the antenna (e.g., the antenna 770).

The first RFICs (e.g., the first RFIC 751, the first RFIC 753, the first RFIC 755, and the first RFIC 757) may be reception RFICs. The second RFIC (e.g., the second RFIC 730) may be a transmission RFIC. Conversely, the first RFICs (e.g., the first RFIC 751, the first RFIC 753, the first RFIC 755, and the first RFIC 757) may be transmission RFICs, and the second RFIC (e.g., the second RFIC 730) may be a reception RFIC.

Table 720 illustrates the space efficiency of the antenna array 710. Referring to table 720, two boards may be required to design a conventional antenna (hereinafter referred to as a conventional antenna) in which a transmission array and a reception array are separated. For example, when configuring a 4×4 array using the conventional antenna, two boards may be required. In contrast, the antenna array 710 may perform both transmission and reception functions within a single board using a 5×5 array. In this case, space efficiency may be 1.28:1 compared to the conventional antenna. When configuring an 8×8 array using the conventional antenna, the antenna array 710 may perform both transmission and reception functions within a single board using a 9×9 array. In this case, space efficiency may be improved to 1.58:1 compared to the conventional antenna. When configuring a 16×16 array using the conventional antenna, the antenna array 710 may perform both transmission and reception functions within a single board using a 17×17 array. In this case, space efficiency may be improved to 1.77:1 compared to the conventional antenna. In addition, when configuring a large-scale 32×32 array using the conventional antenna, the antenna array 710 may perform both transmission and reception functions within a single board using a 33×33 array. In this case, space efficiency may be improved to 1.88:1 compared to the conventional antenna.

The antenna array 710 may include a structure in which a transmission RFIC and a reception RFIC share a single antenna (e.g., the antenna 770). The antenna array 710 may exhibit higher space efficiency compared to a conventional antenna in transmission and reception systems of various scales.

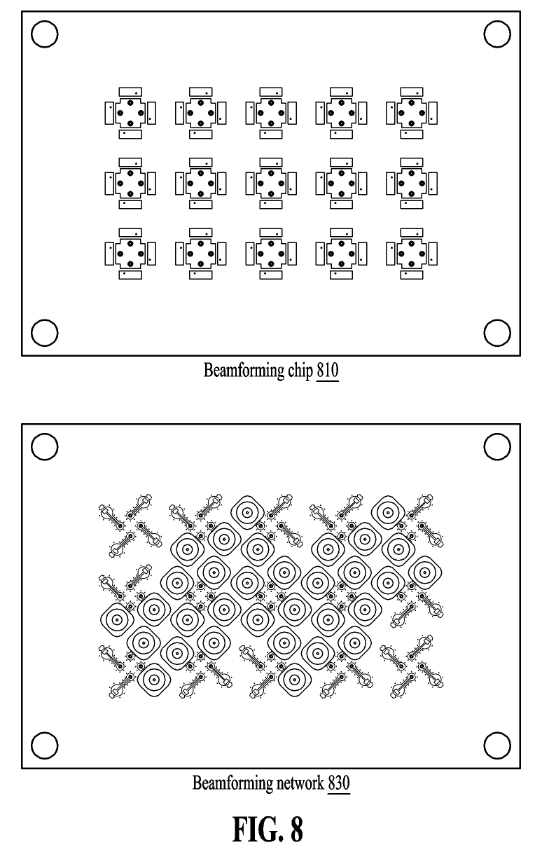

FIG. 8 illustrates a beamformer chip and beamforming network according to an embodiment.

A beamformer chip 810 may control signals supplied to a port of the antenna 300. The beamformer chip 810 may control the phase and the amplitude of the signals. For example, the beamformer chip 810 may control the phase and the amplitude of the signals applied to the port of the antenna 300. The beam direction of an antenna array (e.g., the antenna array 100 of FIG. 1 and/or the antenna array 710 of FIG. 7) may be adjusted.

A beamforming network 830 may control signals distributed to ports of the antenna 300. The beamforming network 830 may obtain signals from the beamformer chip 810. The beamforming network 830 may be connected to the antenna array 100.

The beamformer chip 810 and the beamforming network 830 may be components used in conventional antennas. The antenna 300 may use the beamformer chip 810 and the beamforming network 830 as they are.

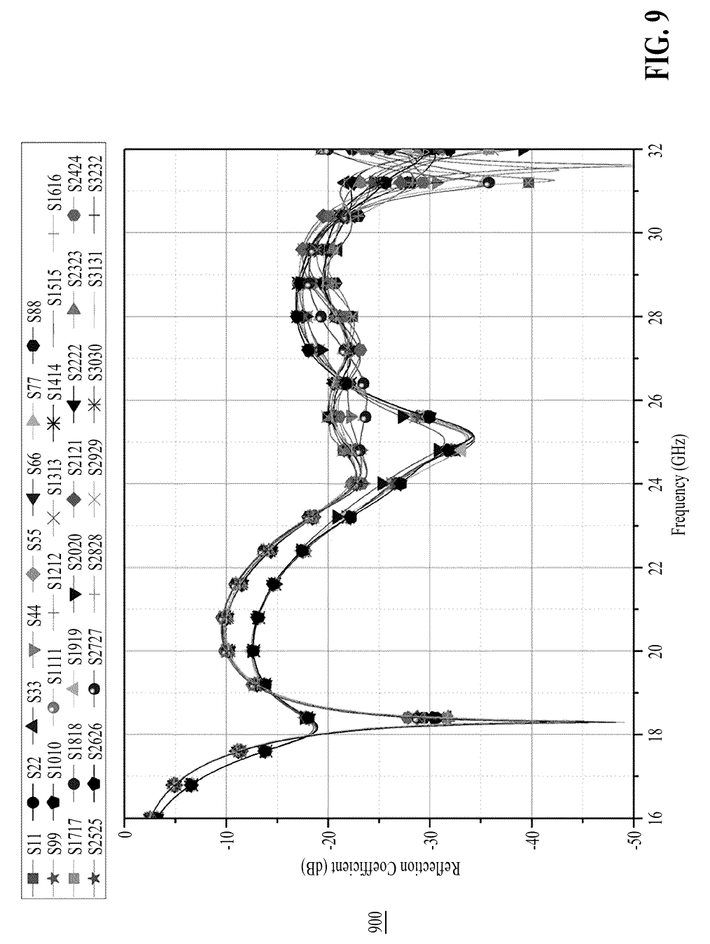

FIG. 9 illustrates reflection coefficients of an antenna according to an embodiment.

Referring to FIG. 9, according to an embodiment, a graph 900 may represent the reflection coefficients of the antenna 300 as functions of frequency.

The antenna 300 may have a plurality of ports. For example, the antenna 300 may have 32 ports. The reflection coefficients of the antenna 300 may be measured for each port. The graph 900 may represent results of measuring reflection coefficients S11, S22, …, S3232 corresponding to the 32 ports of the antenna 300.

The x-axis of graph 900 may represent the magnitude of the reflection coefficients. The magnitude of the reflection coefficients may be represented in decibels (dB). The reflection coefficients of the antenna 300 at each port are maintained at or below -10 dB.

The y-axis of graph 900 may represent the frequency band (in GHz) over which the antenna 300 operates. The antenna 300 may operate across various frequency bands. The antenna 300 may operate within the band ranging from 16 GHz to 32 GHz.

As shown in graph 900, the antenna 300 operates within a specific frequency range and exhibits associated reflection characteristics.

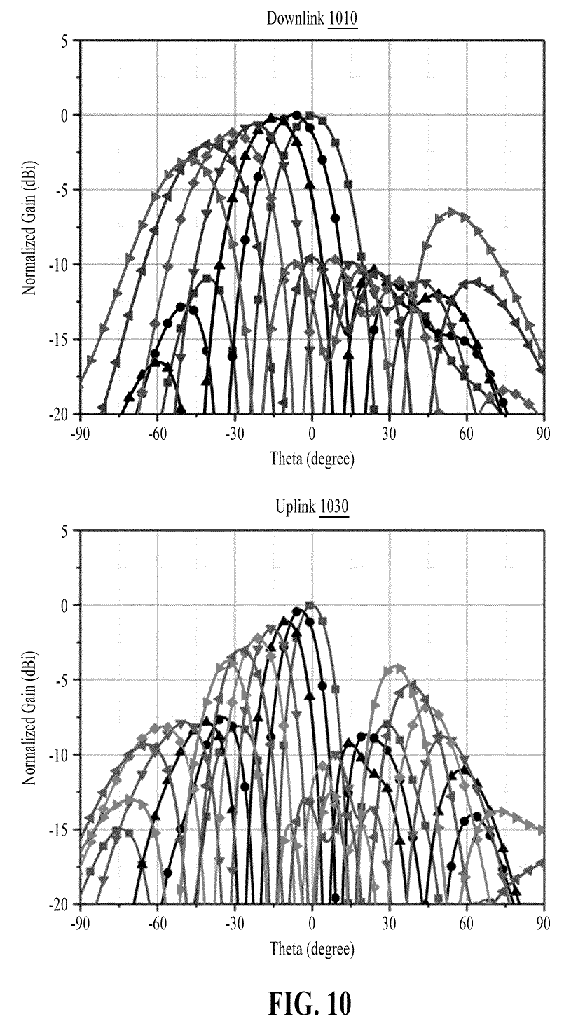

FIG. 10 illustrates a radiation pattern of an antenna according to an embodiment.

Referring to FIG. 10, according to an embodiment, a graph 1010 may represent a radiation pattern of the antenna in a downlink band. A graph 1030 may represent a radiation pattern of the antenna in an uplink band.

The x-axes of graphs 1010 and 1030 may represent a normalized gain of the antenna 300. The magnitude of the normalized gain may be expressed in decibels relative to isotropic (dBi).

The y-axes of graphs 1010 and 1030 may represent radiation directions of the antenna 300.

The graphs 1010 and 1030 may represent distributions of the normalized gain according to various radiation directions of the antenna 300. The graphs 1010 and 1030 may represent relationships between radiation directions and normalized gain of the antenna 300. The graphs 1010 and 1030 may represent radiation characteristics of the antenna 300 in downlink and uplink bands.

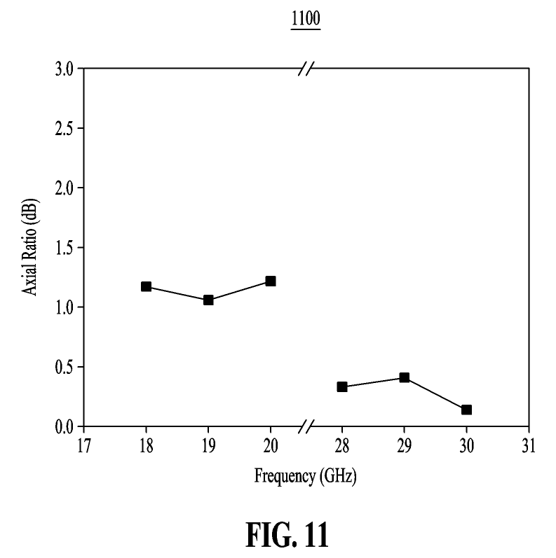

FIG. 11 illustrates a graph of an axial ratio of an antenna according to an embodiment.

Referring to FIG. 11, according to an embodiment, a graph 1100 may represent an axial ratio of the antenna 300 as a function of frequency.

The x-axis of graph 1100 may represent an axial ratio of the antenna 300. The magnitude of the axial ratio may be expressed in decibels (dB). The y-axis of the graph 1100 may represent a frequency band (GHz) over which the antenna 300 operates.

As shown in graph 1100, the axial ratio of the antenna 300 may be maintained at or below 1.5 Db.

FIG. 12 illustrates an antenna manufacturing method according to an embodiment.

In operation 1210, a first RFIC may be disposed on a substrate including a dielectric.

In operation 1230, a second RFIC may be disposed on the substrate, spaced apart from the first RFIC.

The first RFIC may share an antenna with the second RFIC.

Operations 1210 through 1230 may be performed sequentially but are not limited thereto. For example, two or more operations may be performed in parallel.

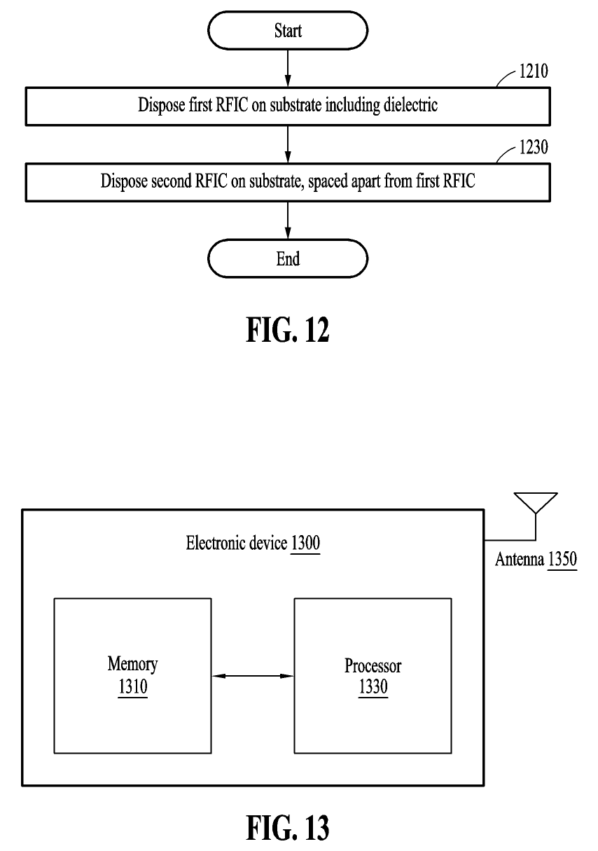

FIG. 13 illustrates a schematic block diagram of an electronic device according to an embodiment.

Referring to FIG. 13, according to an embodiment, an electronic device 1300 may include memory 1310, a processor 1330, and an antenna 1350.

The memory 1310 may store instructions (or programs) executable by the processor 1330. For example, the instructions may include instructions for performing the operation of the processor 1330 and/or the operation of each component of the processor 1330.

The memory 1310 may include one or more computer-readable storage media. The memory 1310 may include non-volatile storage devices (e.g., magnetic hard disks, optical disks, floppy disks, flash memory, electrically programmable read-only memory (EPROM), and electrically erasable programmable read-only memory (EEPROM)).

The memory 1310 may be a non-transitory medium. The term "non-transitory" may indicate that the storage medium is not embodied as a carrier wave or propagated signal. However, the term "non-transitory" should not be interpreted to mean that the memory 1310 is non-movable.

The processor 1330 may process data stored in the memory 1310. The processor 1330 may execute computer-readable code (e.g., software) stored in the memory 1310 and instructions triggered by the processor 1330.

The processor 1330 may be a hardware-implemented data processing device having a circuit that has a physical structure for executing desired operations. For example, the desired operations may include code or instructions contained in a program.

For example, the hardware-implemented data processing device may include a microprocessor, a central processing unit (CPU), a processor core, a multi-core processor, a multiprocessor, an application-specific integrated circuit (ASIC), or a field-programmable gate array (FPGA).

By executing the code and/or instructions stored in the memory 1310, the processor 1330 may cause the electronic device 1300 to perform one or more operations. The operations performed by the electronic device 1300 may be substantially the same as the operations performed by the electronic device 1300 as described with reference to FIGS. 1-12. Therefore, a repeated description thereof is omitted.

What is claimed is:

1. An antenna comprising:
a substrate having a planar structure and including a dielectric;
a first radio-frequency integrated circuit (RFIC) disposed on the substrate; and
a second RFIC disposed on the substrate and spaced apart from the first RFIC,
wherein the first RFIC shares the antenna with the second RFIC.

2. The antenna of claim 1, wherein the first RFIC is a receiver RFIC, and the second RFIC is a transmitter RFIC.

3. The antenna of claim 1, wherein the antenna comprises:
a feeding patch;
a capacitor connected in series to a feeding portion of the feeding patch;
a dummy conductor disposed around a perimeter of the feeding patch; and
a shorting via disposed in the dummy conductor.

4. The antenna of claim 1, wherein a feeding patch of the antenna has a cross shape with each corner of the feeding patch chamfered.

5. The antenna of claim 1, wherein each of the first RFIC and the second RFIC uses two feeding portions of a feeding patch of the antenna.

6. A method of manufacturing an antenna, the method comprising:
disposing a first radio-frequency integrated circuit (RFIC) on a substrate having a planar structure and including a dielectric; and
disposing a second RFIC on the substrate, spaced apart from the first RFIC,
wherein the first RFIC shares the antenna with the second RFIC.

7. The method of claim 6, wherein the first RFIC is a receiver RFIC, and the second RFIC is a transmitter RFIC.

8. The method of claim 6, wherein the antenna comprises:
a feeding patch;
a capacitor connected in series to a feeding portion of the feeding patch;
a dummy conductor disposed around a perimeter of the feeding patch; and
a shorting via disposed in the dummy conductor.

9. The method of claim 6, wherein a feeding patch of the antenna has a cross shape with each corner of the feeding patch chamfered.

10. The method of claim 6, wherein each of the first RFIC and the second RFIC uses two feeding portions of a feeding patch of the antenna.

11. An electronic device for inter-satellite communications, the electronic device comprising:
an antenna;
a processor; and
memory,
wherein the antenna comprises:
a substrate having a planar structure and including a dielectric;
a first radio-frequency integrated circuit (RFIC) disposed on the substrate; and
a second RFIC disposed on the substrate and spaced apart from the first RFIC,
wherein the first RFIC shares the antenna with the second RFIC.

12. The electronic device of claim 11, wherein the first RFIC is a receiver RFIC, and the second RFIC is a transmitter RFIC.

13. The electronic device of claim 11, wherein the antenna comprises:
a feeding patch;
a capacitor connected in series to a feeding portion of the feeding patch;
a dummy conductor disposed around a perimeter of the feeding patch; and
a shorting via disposed in the dummy conductor.

14. The electronic device of claim 11, wherein a feeding patch of the antenna has a cross shape with each corner of the feeding patch chamfered.

15. The electronic device of claim 11, wherein each of the first RFIC and the second RFIC uses two feeding portions of a feeding patch of the antenna.
